(19) United States
(12) Patent Application Publication
(10) Pub. No.: US 2026/0365229 A1
(43) Pub. Date: Nov. 19, 2026

(54) ROTATION RANGE RESTRICTING MECHANISM FOR STEERING WHEEL AND REACTION FORCE APPLICATION DEVICE

(71) Applicant: KYB Corporation, Tokyo (JP)

(72) Inventor: Takaya YAGYU, Gifu (JP)

(73) Assignee: KYB Corporation, Tokyo (JP)

(21) Appl. No.: 19/144,101

(22) PCT Filed: Nov. 28, 2023
(86) PCT No.: PCT/JP2023/042458

§ 371 Date: Jun. 27, 2025

(30) Foreign Application Priority Data
Dec. 28, 2022 (JP) 2022-211376

(51) Int. Cl. B62D 5/04; B62D 1/16; B62D 3/06

(52) U.S. Cl. CPC B62D 5/043; B62D 1/16; B62D 3/06

(57) ABSTRACT

The rotation range restricting mechanism includes the case and the plurality of disks, the plurality of disks each have: the boss portion formed on the main body portion so as to protrude from the main body portion in one of the axial directions; the boss receiving portion; and the stopper portion formed on the outer circumferential surface of the main body portion so as to be slidable along the outer circumferential surface of the disk stacked adjacently, the plurality of disks are rotated together as the stopper portions of the disks stacked adjacently come into contact with each other, and the case has the restricting portion configured to restrict rotation of the disks as a whole as the stopper portion of the disk stacked on the bottom surface of the accommodating hole comes into contact with the restricting portion.

### TECHNICAL FIELD

The present invention relates to a rotation range restricting mechanism for a steering wheel and a reaction force application device.

### BACKGROUND ART

JP2013-1183A discloses a vehicle steering device, in which a mechanical connection between a steering member and a steering wheel is released, having a configuration including a housing, a shaft that is rotated by rotating operation of the steering member, and a rotation restricting mechanism that restricts an rotated amount of the steering member to a predetermined angle or less.

The rotation restricting mechanism is provided at an end portion of the shaft. The rotation restricting mechanism is provided coaxially with the rotation axis of the shaft and has a rotatable element that is rotated integrally with the shaft and a non-rotatable element that is provided in the housing by being arranged so as to face the rotatable element and that is not rotatable relative to the rotatable element. Between the non-rotatable element and the rotatable element, a plurality of intermediate elements are provided so as to be aligned in the axial direction of the shaft by being fitted to an outer circumferential surface of the shaft. Between the plurality of intermediate elements, friction imparting elements, which are not fitted to the outer circumferential surface of the shaft, are respectively provided. By the frictional force generated between the friction imparting elements and members adjacent to the friction imparting elements, the rotated amount of the steering member is restricted. A bearing for supporting the non-rotatable element to the shaft is provided between the shaft and the non-rotatable element.

### SUMMARY OF INVENTION

In the rotation restricting mechanism described in JP2013-1183A, the shaft is provided so as to penetrate through the plurality of intermediate elements and a plurality of friction imparting elements, and the bearing for receiving the rotation of the shaft is provided in the non-rotatable element. In addition, the plurality of intermediate elements that are rotated integrally with the shaft are provided separately from the plurality of friction imparting elements and the non-rotatable element that restrict the rotation of the shaft. Therefore, there are large number of parts for the rotation restricting mechanism, and the manufacture of the rotation restricting mechanism takes a lot of effort.

An object of the present invention is to provide a rotation range restricting mechanism having a simple configuration.

According to one aspect of the present invention, rotation range restricting mechanism for a steering wheel of a steering device, in which the steering wheel into which steering torque is input and a wheel steered in response to the steering torque are mechanically separated, the rotation range restricting mechanism includes: a case having an accommodating hole; and a plurality of rotating members linked to a steering shaft and accommodated in the accommodating hole by being stacked, the steering shaft being configured to be rotated in accordance with rotation of the steering wheel, the plurality of rotating members each have: a main body portion having a disk shape; a boss portion formed on the main body portion so as to protrude from the main body portion in one of axial directions; a boss receiving portion formed in a surface of the main body portion opposite from the boss portion, the boss receiving portion being configured to rotatably support the boss portion of a rotating member stacked adjacently; and a stopper portion formed on an outer circumferential surface of the main body portion so as to be slidable along an outer circumferential surface of the rotating member stacked adjacently, the plurality of rotating members are rotated together as the stopper portions of the rotating members stacked adjacently come into contact with each other, and the case has a restricting portion configured to restrict rotation of the rotating members as a whole as the stopper portion of the rotating member stacked on a bottom surface of the accommodating hole comes into contact with the restricting portion.

### BRIEF DESCRIPTION OF DRAWINGS

FIG. 1 is a configuration diagram of a steering device.

FIG. 2 is a perspective view showing a reaction force application device according to an embodiment of the present invention.

FIG. 3 is an exploded perspective view showing the rotation range restricting mechanism according to the embodiment of the present invention.

FIG. 4 is a partial perspective view of the rotation range restricting mechanism according to the embodiment of the present invention, showing it with a portion of a case omitted.

FIG. 5 is a perspective view showing an upper surface side of a disk.

FIG. 6 is a perspective view showing a lower surface side of the disk.

FIG. 7 is a partial perspective view of the case.

FIG. 8 is a top view of the case.

FIG. 9 is a partial perspective view (Part 1) showing rotating motion of a plurality of disks, and is shown in a manner corresponding to FIG. 4.

FIG. 10 is a partial perspective view (Part 2) showing the rotating motion of the plurality of disks, and is shown in a manner corresponding to FIG. 4.

FIG. 11 is a partial perspective view (Part 3) showing the rotating motion of the plurality of disks, and is shown in a manner corresponding to FIG. 4.

FIG. 12 is a partial perspective view (Part 4) showing the rotating motion of the plurality of disks, and is shown in a manner corresponding to FIG. 4.

### DESCRIPTION OF EMBODIMENTS

A rotation range restricting mechanism 100 according to an embodiment of the present invention will be described with reference to the drawings. In this embodiment, the rotation range restricting mechanism 100 is provided on a steering device 1 serving as a steering device.

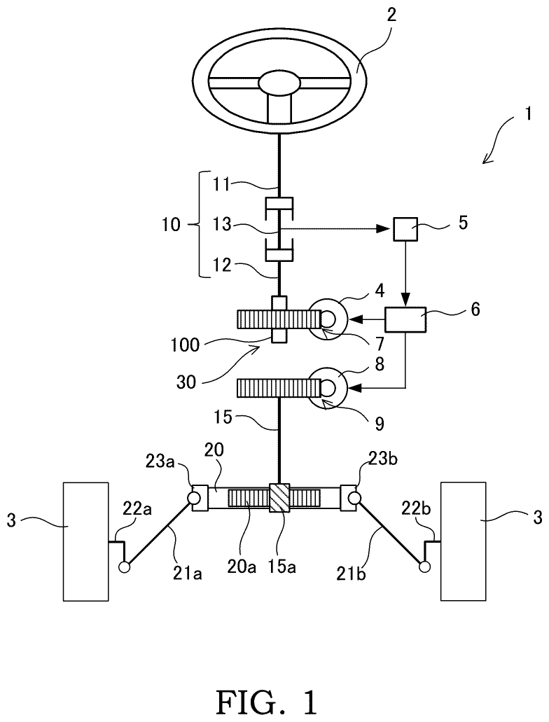

In the steering device 1 shown in FIGS. 1 to 3, a steer-by-wire control by which steering of wheels 3 is controlled in accordance with operation of a steering wheel 2 performed by a driver is performed. In the steering device 1, the steering wheel 2, into which the steering torque is input by the driver, and the wheels 3 that are steered in response to the steering torque are mechanically separated.

As shown in FIG. 1, the steering device 1 has: a steering shaft 10 that is linked to the steering wheel 2 and is rotated in accordance with the rotation of the steering wheel 2; a torque sensor 5 that detects the torque that acts on a torsion bar 13 of the steering shaft 10; a rack shaft 20 that steers the wheels 3 in accordance with the rotation of the steering shaft 10; an electric motor 8 for displacing the rack shaft 20; and a controller 6 that controls driving of the electric motor 8 in accordance with detected value from the torque sensor 5.

The steering shaft 10 is configured of: an input shaft 11 that is rotated in accordance with the steering operation in which the driver operates the steering wheel 2; a reaction force shaft 12 into which the reaction force is input from a reaction motor 4 as described later; and the torsion bar 13 that links the input shaft 11 and the reaction force shaft 12.

The rack shaft 20 is a shaft member that is provided so as to extend in the left-right direction of a vehicle. The rack shaft 20 is linked to one wheel 3 via a first tie rod 21a and a first knuckle arm 22a and is linked to the other wheel 3 via a second tie rod 21b and a second knuckle arm 22b.

The first and second tie rods 21a and 21b are linked to the rack shaft 20 so as to be respectively swingable via first and second ball joints 23a and 23b, each serving as a linkage portion, that are provided on both end portions of the rack shaft 20. Note that, as the linkage portions for linking the rack shaft 20 with the first and second tie rods 21a and 21b, they are not limited to the first and second ball joints 23a and 23b, and universal joints of other types may also be used.

The controller 6 is formed of a microcomputer including a CPU (Central Processing Unit) that carries out computational processing, a ROM (Read-Only Memory) that stores a control program, etc. to be executed by the CPU, and a RAM (random access memory) that stores computed results, etc. from the CPU. The controller 6 may be formed of a single microcomputer or of a plurality of microcomputers.

The torque sensor 5 detects the steering torque imparted to the input shaft 11 by the steering operation performed by the driver and outputs a signal corresponding to thus-detected steering torque to the controller 6. The controller 6 computes a torque to be output from the electric motor 8 on the basis of the signal from the torque sensor 5 and controls the driving of the electric motor 8 such that the torque is generated accordingly. The torque from the electric motor 8 is transmitted to an output shaft 15 via a speed reducer 9.

The output shaft 15 and the rack shaft 20 are linked with each other via a rack-and-pinion mechanism formed of a pinion gear 15a that is provided at an end portion of the output shaft 15 and a rack gear 20a that is provided on the rack shaft 20. The pinion gear 15a and the rack gear 20a are meshed with each other, and the torque from the output shaft 15 is transmitted to the rack shaft 20 by being converted into a load in the axial direction of the rack shaft 20 via the pinion gear 15a and the rack gear 20a. As a result, the rack shaft 20 is displaced in the axial direction by the transmitted torque and steers the wheels 3 via the first and second tie rods 21a and 21b.

As described above, in the steering device 1 having the above-described configuration, the wheels 3 are steered when the steering torque imparted to the input shaft 11 is detected by the torque sensor 5, and the driving of the electric motor 8 is controlled by the controller 6 on the basis of the detected result.

In the above, in a steering device in which a steering wheel and wheels are linked mechanically, when a rack shaft, which is linked to the steering wheel and steers the wheels, is moved to the stroke end, the movement of the rack shaft is restricted, and thereby, the rotation of the steering wheel is restricted at the maximum steering angle. However, in the steering device 1 according to the present embodiment, in which the steer-by-wire control is performed, because the steering wheel 2, into which the steering torque is input by the driver, and the wheels 3, which are steered in response to the steering torque, are mechanically separated, it is not possible to restrict the rotation of the steering wheel 2 via the rack shaft 20. Therefore, in the steering device 1, in order to restrict the rotation of the steering wheel 2 at the maximum steering angle, the rotation range restricting mechanism 100 is provided on the steering shaft 10 (specifically, the reaction force shaft 12). In other words, by restricting the rotation of the steering shaft 10 by the rotation range restricting mechanism 100, the rotation of the steering wheel 2 is restricted at the maximum steering angle.

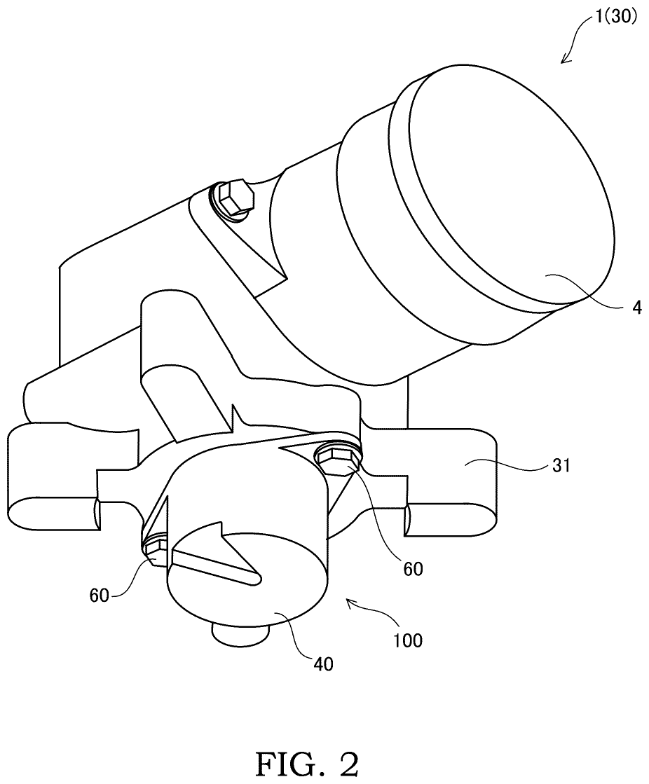

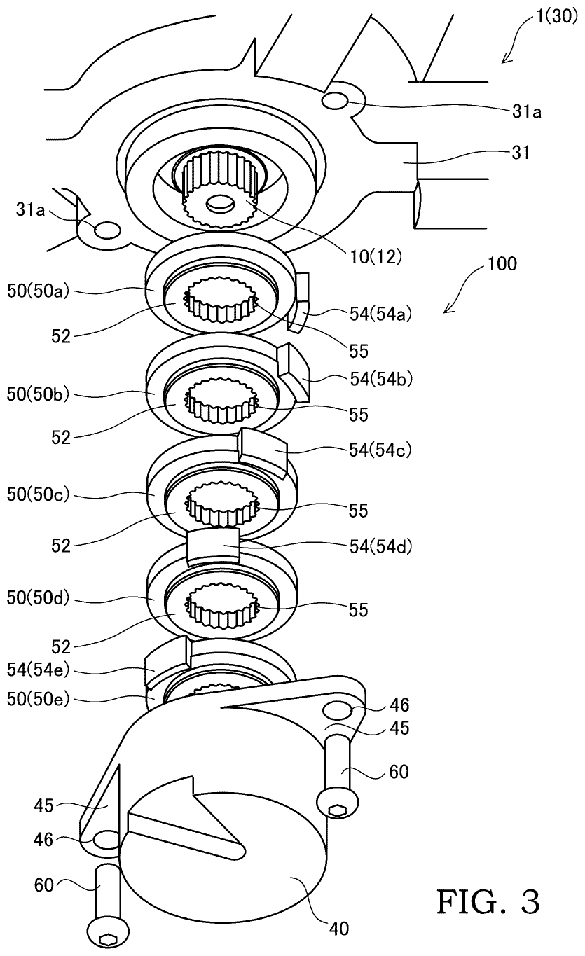

In addition, the steering device 1 has the reaction motor 4 that applies the steering reaction force transmitted to the wheels 3 from road surface, etc. to the steering wheel 2 (see FIGS. 1 and 2). The reaction motor 4 is controlled by the controller 6. The torque from the reaction motor 4 is transmitted to the steering wheel 2 via a speed reducer 7 and the steering shaft 10. As a result, the steering reaction force is applied to the steering wheel 2. A reaction force application device 30 that applies the reaction force to the steering shaft 10 is formed with the reaction motor 4 and the rotation range restricting mechanism 100. The rotation range restricting mechanism 100 is attached to a housing 31 of the reaction motor 4. Note that, in FIGS. 2 and 3, only the reaction force application device 30 in the steering device 1 is shown.

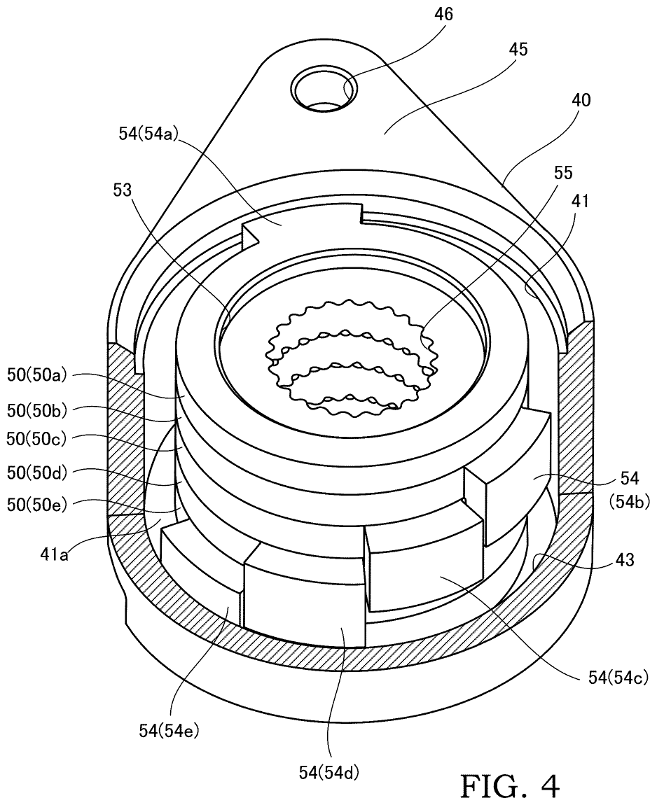

As shown in FIGS. 3 and 4, the rotation range restricting mechanism 100 includes a case 40 having an accommodating hole 41 and disks 50 serving as a plurality of rotating members that are linked to the steering shaft 10 and that are accommodated in the accommodating hole 41 by being stacked.

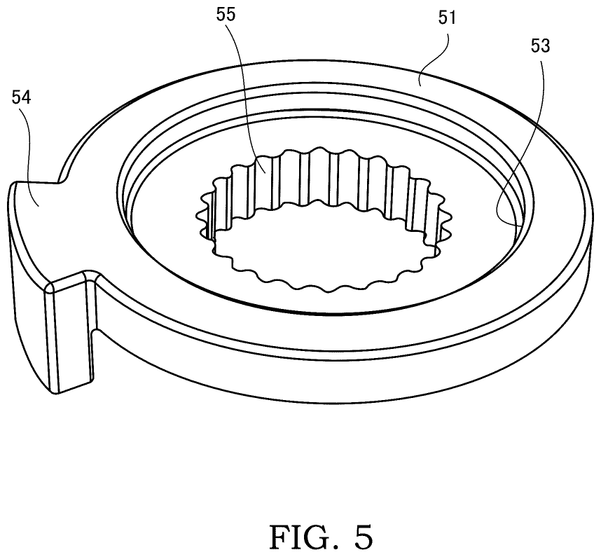

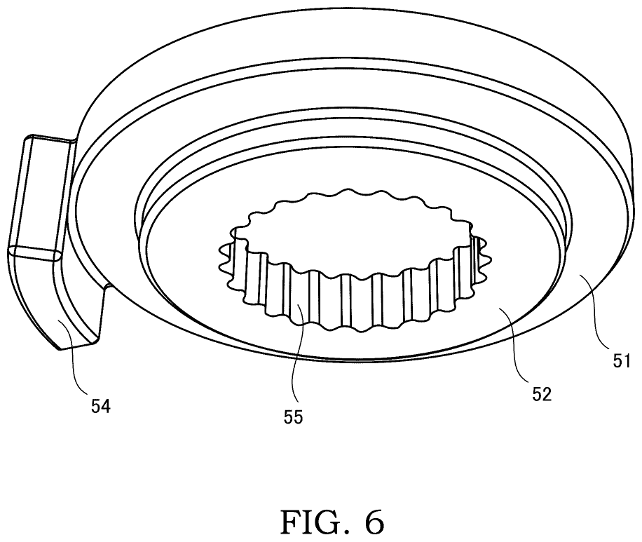

First, the configuration of the disks 50 will be described in detail. In this embodiment, the rotation range restricting mechanism 100 includes five disks 50. Note that, the number of the disks 50 is not limited to five as long as there are multiple disks. The plurality of disks 50 are formed in the same shape as each other. The plurality of disks 50 are formed of metal, for example. Note that, the plurality of disks 50 may also be formed of resin, etc. FIG. 5 is a perspective view showing an upper surface side of one disk 50, and FIG. 6 is a perspective view showing a lower surface side of one disk 50. As shown in FIGS. 5 and 6, the disk 50 has: a main body portion 51 having a disk shape; a boss portion 52 that is formed on the main body portion 51 so as to protrude from the main body portion 51 in one of the axial directions (see FIG. 6); a boss receiving portion 53 that is formed in the surface of the main body portion 51 opposite from the boss portion 52 and that supports, in a rotatable manner, the boss portion 52 of the disk 50 that is stacked adjacently (see FIG. 5); a stopper portion 54 that is formed on an outer circumferential surface of the main body portion 51 and that is slidable along the outer circumferential surface of the disk 50 that is stacked adjacently; and a coupling portion 55 that can couple with the steering shaft 10.

The boss portion 52 and the boss receiving portion 53 are formed to have shapes corresponding to each other. Specifically, the boss portion 52 is formed to have a cylindrical shape concentric with the main body portion 51, and the boss receiving portion 53 is formed as an accommodating hole concentric with the main body portion 51. The outer diameter of the boss portion 52 is slightly smaller than the inner diameter of the boss receiving portion 53, and the height of the boss portion 52 in the axial direction and the depth of the boss receiving portion 53 in the axial direction are substantially the same. In the rotation range restricting mechanism 100, as the boss receiving portion 53 of the disk 50 is received and supported by the boss portion 52 of another disk 50, the disks 50 are aligned with each other, and the boss portion 52 and the boss receiving portion 53 are brought into sliding contact, and thereby, the disks 50 are stacked so as to be rotatable relative to each other (see FIGS. 3 and 4). In this embodiment, the plurality of disks 50 are stacked such that the respective boss portions 52 face downward. Note that, a lubricant such as grease, etc. may be provided between the boss portion 52 and the boss receiving portion 53.

The stopper portion 54 is formed so as to protrude radially from the outer circumferential surface of the main body portion 51 and so as to protrude in the axial direction from one surface of the main body portion 51 in the axial direction. In this embodiment, the stopper portion 54 is formed so as to protrude in the axial direction from the surface of the main body portion 51, in which the boss portion 52 is formed (see FIG. 6), and is formed flush with the surface of the main body portion 51 in which the boss receiving portion 53 is formed (see FIG. 5). Therefore, as the disk 50 is rotated, the stopper portion 54 can come into contact with the stopper portion 54 of the disk 50 that is stacked adjacently. The stopper portion 54 is formed so as to extend in the circumferential direction in a manner concentric with the main body portion 51. The stopper portion 54 is formed so as not to come in to sliding contact with the outer circumferential surface of the main body portion 51 of the disk 50 that is stacked adjacently when the disk 50 is rotated.

The coupling portion 55 is formed at the center of the disk 50 so as to penetrate the disk 50 in the axial direction. The coupling portion 55 is concentric with the main body portion 51 and is formed to have a shape that fits together with the steering shaft 10. The steering shaft 10 and the disk 50 are coupled by a spline coupling. In this embodiment, among the plurality of stacked disks 50, only a (uppermost) disk 50a, which is the closest to the steering shaft 10, is coupled to the steering shaft 10 via the coupling portion 55, and the disk 50a is rotated along with the rotation of the steering shaft 10. In addition, the plurality of disks 50 are integrally rotated as the stopper portions 54 of the disks 50 that are stacked adjacently come into contact with each other. The motion in which the plurality of disks 50 are rotated will be described later. In the following, the second disk 50 from the top is also referred to as a disk 50b, the third disk 50 from the top is also referred to as a disk 50c, the fourth disk 50 from the top is also referred to as a disk 50d, and the bottommost disk 50 is also referred to as a disk 50e. In addition, the stopper portions 54 of the disks 50a to 50e are respectively referred to as stopper portions 54a to 54e.

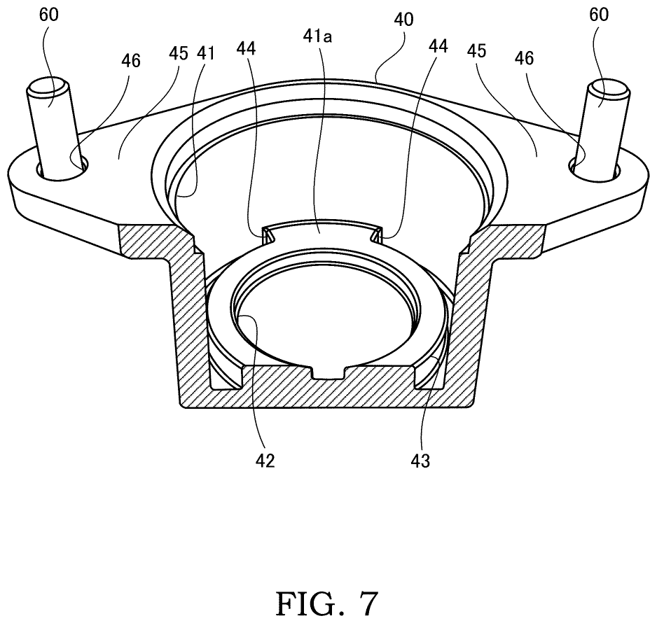

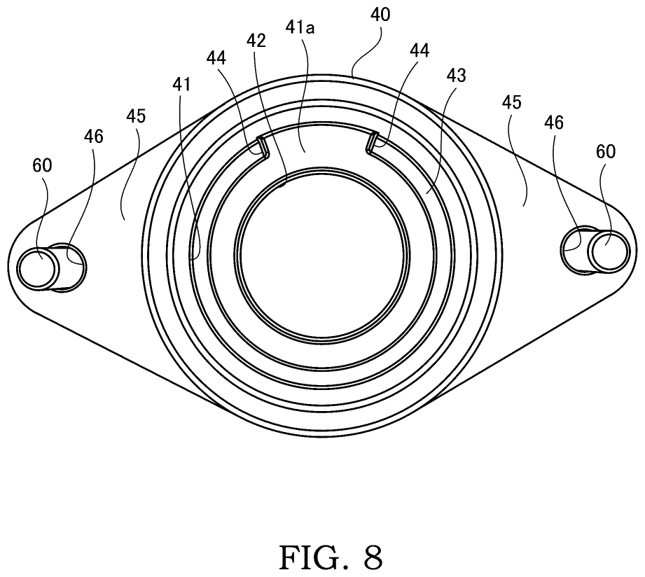

Next, the configuration of the case 40 will be described in detail. FIG. 7 is a partial perspective view of the case 40, and FIG. 8 is a top view of the case 40. As shown in FIGS. 7 and 8, the case 40 is formed to have a bottomed cylindrical shape. The case 40 has the accommodating hole 41 into which the plurality of disks 50 are accommodated and flanges 45 serving as a pair of attachment portions for attaching the case 40 to the housing 31 of the reaction motor 4.

The accommodating hole 41 is formed to have such a size that the outer circumferential surface of the disk 50 does not come into contact with an inner circumferential surface of the accommodating hole 41 even when the disk 50 is rotate. A bottom surface 41a of the accommodating hole 41 is formed with: a case-side boss receiving portion 42 having a recessed shape that supports, in a rotatable manner, the boss portion 52 of the disk 50e that is stacked on the bottom surface 41a; and a groove 43 that guides a stopper portion 54e of the disk 50e. Similarly to the boss receiving portion 53 of the disk 50, the case-side boss receiving portion 42 is formed to have a shape corresponding to the boss portion 52 of the disk 50e. The groove 43 is formed so as to extend in the circumferential direction such that a part of the stopper portion 54e of the disk 50e is received in the groove 43. When the disk 50e is rotated, because the stopper portion 54e is guided along the groove 43, the disk 50e is rotated stably. At end portions of the groove 43, restricting portions 44 to which the stopper portion 54e comes into contact are formed. Two restricting portions 44 are formed on both end portions of the groove 43 in the circumferential direction. As the stopper portion 54e comes into contact with the restricting portion 44, the rotation of the disk 50e is restricted. When the plurality of disks 50 are accommodated in the accommodating hole 41, the boss portion 52 of the disk 50e is received in the case-side boss receiving portion 42, and a part of the stopper portion 54e of the disk 50e is received in the groove 43.

A pair of flanges 45 are formed so as to project out from an outer circumferential surface of the case 40 in the radial direction. The pair of flanges 45 are each formed with a through hole 46. A bolt 60 serving as a fastening member is inserted into each through hole 46. In addition, the housing 31 that receives the reaction motor 4 is formed with two threaded holes 31a so as to correspond to the respective through holes 46 (see FIG. 3). The rotation range restricting mechanism 100 is assembled by accommodating the stacked plurality of disks 50 in the accommodating hole 41 of the case 40 and is attached to the housing 31 by placing the pair of flanges 45 of the case 40 to face the housing 31 and by respectively inserting the bolts 60 into the through holes 46 of the case 40 and the threaded holes 31a of the housing 31. In a state in which the rotation range restricting mechanism 100 is attached to the housing 31, among the plurality of stacked disks 50, only the (uppermost) disk 50a, which is the closest to the steering shaft 10, is coupled to the steering shaft 10 via the coupling portion 55.

Next, the rotating motion of the plurality of disks 50 will be described in detail.

In a state shown in FIG. 4, the disk 50e that is stacked on the bottom surface 41a of the case 40 is in a state in which stopper portion 54e is in contact with the restricting portion 44, and thereby, the rotation of the disk 50e in the clockwise direction is restricted. In addition, the disk 50d that is stacked on the disk 50e is in a state in which a stopper portion 54d is in contact with the stopper portion 54e of the disk 50e. Because the rotation of the disk 50e in the clockwise direction is restricted by the restricting portion 44, the rotation of the disk 50d in the clockwise direction is also restricted. Similarly, the disk 50c that is stacked on the disk 50d is in a state in which a stopper portion 54c is in contact with the stopper portion 54d of the disk 50d, and thereby, the rotation thereof in the clockwise direction is restricted, and the disk 50b that is stacked on the disk 50c is in a state in which a stopper portion 54b is in contact with the stopper portion 54c of the disk 50c, and thereby, the rotation thereof in the clockwise direction is restricted. A stopper portion 54a of the disk 50a that is stacked on the disk 50b is not in contact with the stopper portion 54b of the disk 50b. Thus, the disk 50a can be rotated in the clockwise and counterclockwise directions. Therefore, the steering shaft 10 to which the disk 50a is coupled and the steering wheel 2 can also be rotated in the clockwise and counterclockwise directions.

From the state shown in FIG. 4, when the steering wheel 2 is rotated in the clockwise direction and the steering shaft 10 and the disk 50a are rotated in the clockwise direction, the stopper portion 54a comes into contact with the stopper portion 54b of the disk 50b. When the stopper portion 54a comes into contact with the stopper portion 54b of the disk 50b, the rotation of the disk 50a in the clockwise direction is restricted. Thus, the rotation of the disks 50a to 50e as a whole in the clockwise direction is restricted. Therefore, the rotation of the steering shaft 10 and the steering wheel 2 in the clockwise direction is restricted at the maximum steering angle.

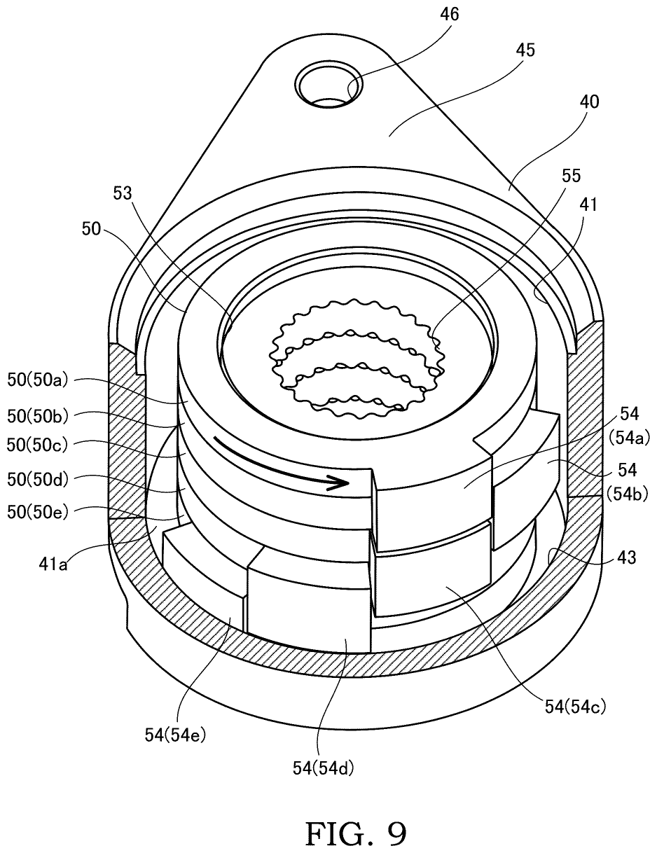

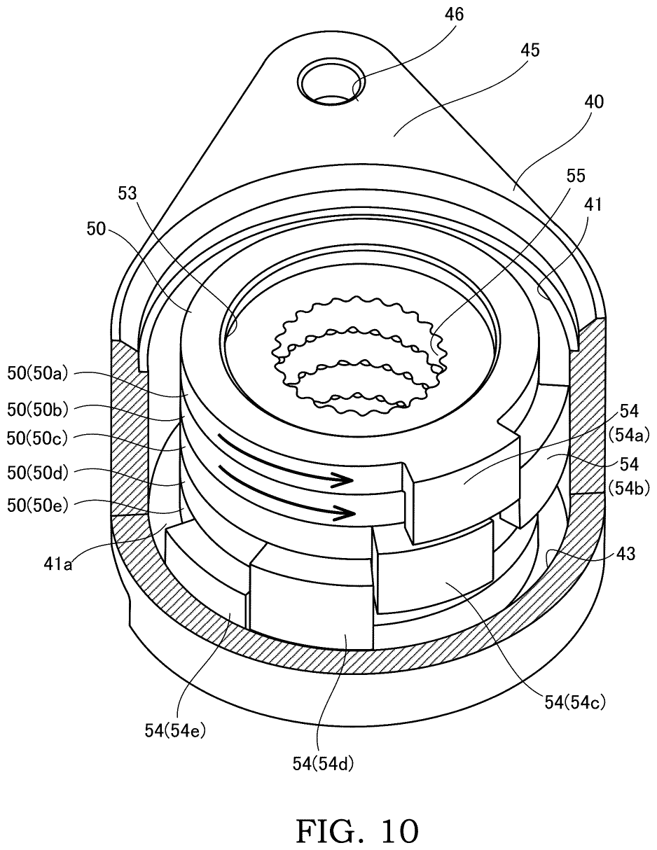

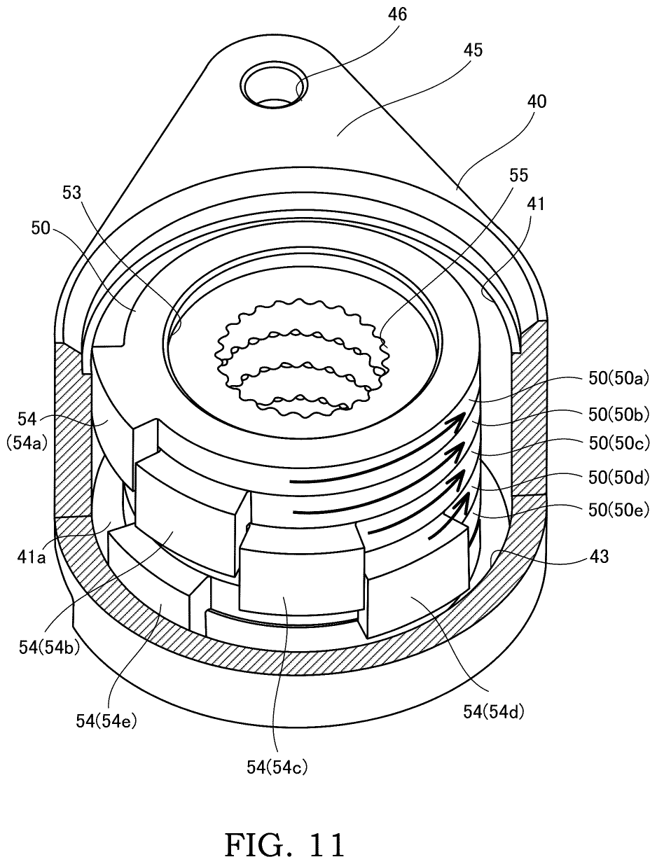

From the state shown in FIG. 4, when the steering wheel 2 is rotated in the counterclockwise direction and the steering shaft 10 and the disk 50a are rotated in the counterclockwise direction, as shown in FIG. 9, the stopper portion 54a comes into contact with the stopper portion 54b. The rotation of the disk 50b in the counterclockwise direction is not restricted. Therefore, when the disk 50a is rotated in the counterclockwise direction and the stopper portion 54a comes into contact with the stopper portion 54b, the rotational torque of the stopper portion 54a is transmitted to the stopper portion 54b, and as shown in FIG. 10, the disk 50b is rotated together with the disk 50a. When the steering wheel 2 is further rotated in the counterclockwise direction and the stopper portion 54b comes into contact with the stopper portion 54c, the rotational torque of the stopper portion 54b is transmitted to the stopper portion 54c in a similar manner, and the disk 50c is rotated together with the disks 50a and 50b (not shown). When the steering wheel 2 is additionally rotated in the counterclockwise direction, and the stopper portion 54c comes into contact with the stopper portion 54d, as shown in FIG. 11, the disk 50d is rotated together with the disks 50a to 50c.

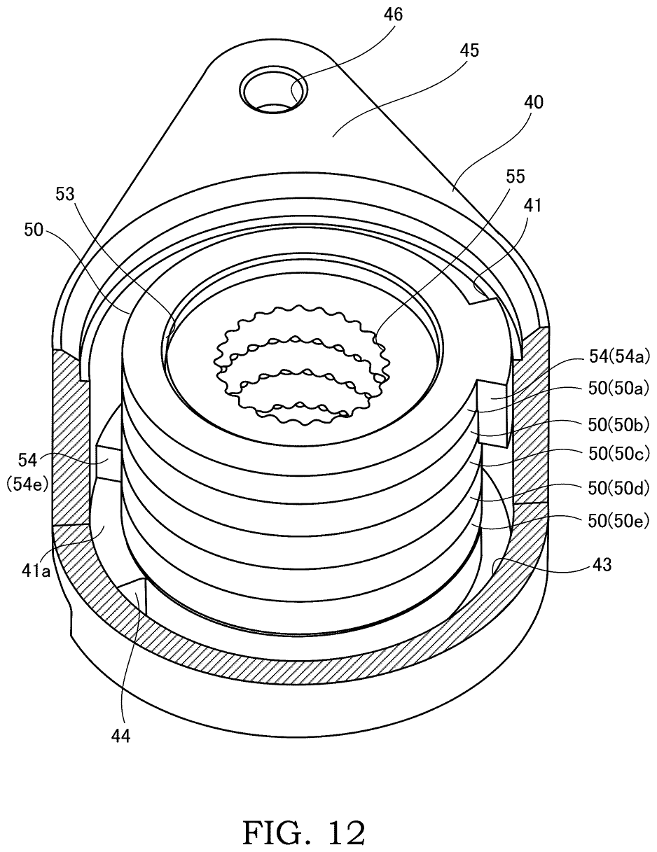

From the state shown in FIG. 11, when the steering wheel 2 is rotated in the counterclockwise direction and the stopper portion 54d comes into contact with the stopper portion 54e, the disk 50e is rotated together with the disks 50a to 50d in a similar manner (not shown). When the steering wheel 2 is further rotated in the counterclockwise direction, as shown in FIG. 12, the stopper portion 54e comes into contact with the restricting portion 44. As a result, the rotation of the disk 50e in the counterclockwise direction is restricted, and the rotation of the disks 50a to 50e as a whole in the counterclockwise direction is restricted. Therefore, the rotation of the steering shaft 10 and the steering wheel 2 in the counterclockwise direction is restricted at the maximum steering angle. As described above, the restricting portions 44 are configured such that the rotation of the disks 50a to 50e as a whole is restricted when the stopper portion 54e comes into contact with the restricting portions 44.

As described above, in the rotation range restricting mechanism 100, the plurality of disks 50 are rotatably stacked via the boss portions 52 and the boss receiving portions 53. Therefore, there is no need to provide a shaft penetrating through the plurality of disks 50 and a bearing that supports such a shaft in the rotation range restricting mechanism 100 in order to support the plurality of disks 50. In addition, in the rotation range restricting mechanism 100, the stopper portion 54 for transmitting the rotation of the steering wheel 2 is formed integrally to the disk 50, and as the stopper portion 54e of the disk 50e, which is stacked on the bottom surface 41a of the accommodating hole 41 in the case 40, comes into contact with the restricting portion 44 of the case 40, the rotation of the disk 50 as a whole is restricted. Therefore, there is no need to separately provide a member for transmitting the rotation of the steering wheel 2 and a member for restricting the rotation of the disk 50. Thus, the number of parts of the rotation range restricting mechanism 100 is reduced, and thus, it is possible to restrict the rotation of the steering wheel 2 with a simple configuration.

In addition, in the rotation range restricting mechanism 100, among the plurality of stacked disks 50, only the (uppermost) disk 50a, which is the closest to the steering shaft 10, is coupled to the steering shaft 10 via the coupling portion 55. Thus, during the assembly of the rotation range restricting mechanism 100, there is no need to couple the steering shaft 10 to all of the plurality of disks 50. Therefore, the assembly of the rotation range restricting mechanism 100 becomes easier.

In addition, in the rotation range restricting mechanism 100, the plurality of disks 50 are formed in the same shape as each other. As a result, because the disks 50 having the same shape can be used, it is possible to make the manufacture and the assembly of the rotation range restricting mechanism 100 easier.

In addition, in the rotation range restricting mechanism 100, because the groove 43 and the restricting portions 44 are formed in the case 40 for receiving the plurality of disks 50, the number of parts of the rotation range restricting mechanism 100 is reduced.

In addition, in the present embodiment, it is possible to apply the rotation range restricting mechanism 100 to the reaction force application device 30 only by attaching the case 40 to the housing 31 of the reaction motor 4.

Note that, the rotation range of the steering wheel 2 is adjusted by the length of the stopper portion 54 in the circumferential direction and the number of the disks 50. By adjusting the length of the stopper portion 54 in the circumferential direction, it is possible to adjust the rotation range of the rotation of one disk 50 in the clockwise and counterclockwise directions until the one disk 50 comes into contact with the stopper portion 54 of the disk 50 that is stacked adjacently. In this embodiment, the length of the stopper portion 54 in the circumferential direction is adjusted such that the rotation range of one disk 50 becomes 288 degrees (in other words, 144 degrees in both the clockwise and counterclockwise directions from the neutral position). Specifically, the stopper portion 54 is formed such that the angle in the circumferential direction becomes 72 degrees. In addition, each time one disk 50 is stacked, the rotation range of the plurality of disks 50 as a whole is increased by 288 degrees. In this embodiment, as described above, the rotation range restricting mechanism 100 have five disks 50. Therefore, for the plurality of disks 50 as a whole, the rotation range until the stopper portion 54e of the disk 50e comes into contact with the restricting portions 44 becomes 1440 degrees. In other words, in the rotation range restricting mechanism 100 according to the present embodiment, the rotation range of the steering wheel 2 is 720 degrees in both the clockwise and counterclockwise directions from the neutral position, and so it is possible to rotate the steering wheel 2 two full rotations in both in the clockwise and counterclockwise directions from the neutral position. In the rotation range restricting mechanism 100, it is possible to adjust the rotation range of the steering wheel 2 easily in this manner.

According to the above-described embodiment, operational advantages shown below can be afforded.

In the rotation range restricting mechanism 100, the plurality of disks 50 are rotatably stacked via the boss portions 52 and the boss receiving portions 53. Therefore, there is no need to provide a shaft penetrating through the plurality of disks 50 and a bearing that supports such a shaft in the rotation range restricting mechanism 100 in order to support the plurality of disks 50. In addition, in the rotation range restricting mechanism 100, the stopper portion 54 for transmitting the rotation of the steering wheel 2 is formed integrally to the disk 50, and as the stopper portion 54e of the disk 50e, which is stacked on the bottom surface 41a of the accommodating hole 41 in the case 40, comes into contact with the restricting portion 44 of the case 40, the rotation of the disk 50 as a whole is restricted. Therefore, the number of parts of the rotation range restricting mechanism 100 is reduced, and thus, it is possible to restrict the rotation of the steering wheel 2 with a simple configuration.

In the rotation range restricting mechanism 100, among the plurality of stacked disks 50, only the disk 50a, which is the closest to the steering shaft 10, is coupled to the steering shaft 10 via the coupling portion 55. Thus, the assembly of the rotation range restricting mechanism 100 becomes easier.

In the rotation range restricting mechanism 100, the plurality of disks 50 are formed in the same shape as each other. As a result, because the disks 50 having the same shape can be used, it is possible to make the manufacture and the assembly of the rotation range restricting mechanism 100 easier.

In the rotation range restricting mechanism 100, because the groove 43 and the restricting portions 44 are formed in the case 40 for receiving the plurality of disks 50, the number of parts of the rotation range restricting mechanism 100 is reduced.

In the steering device 1, it is possible to attach the rotation range restricting mechanism 100 to the housing 31 of the reaction motor 4 and to apply the rotation range restricting mechanism 100 to the reaction force application device 30.

Following modifications are also within the scope of the present invention, and it is also possible to combine the configurations shown in the modification with the configurations described in the above-described embodiment, and to combine the configurations described in the following different modifications.

### First Modification

In the above-described embodiment, the plurality of disks 50 are formed in the same shape as each other. The present invention is not limited thereto, and the plurality of disks 50 may be formed to have different shapes from each other. It suffices that the plurality of disks 50 each have the configuration including at least the main body portion 51, the boss portion 52, the boss receiving portion 53, and the stopper portion 54, and it suffices that the coupling portion 55 is formed in at least the uppermost disk 50a.

### Second Modification

In the above-described embodiment, the boss portion 52 is formed to have the cylindrical shape concentric with the main body portion 51. However, as long as the boss portion 52 has the configuration in which the boss portion 52 is received and rotatably stacked in the boss receiving portion 53, the shape of the boss portion 52 is not limited to the above-described shape, and may be formed to have a polygonal shape, for example.

### Third Modification

In the above-described embodiment, the restricting portions 44 are formed on the end portions of the groove 43 in the case 40. In other words, the restricting portions 44 are formed integrally with the case 40. The present invention is not limited thereto, and it may be possible to employ a configuration in which the restricting portions 44 are formed separately from the case 40 and attached to the case 40.

### Fourth Modification

In the above-described embodiment, the rotation range restricting mechanism 100 is linked to the steering shaft 10 by being attached to the housing 31 of the reaction motor 4. However, as long as the rotation range restricting mechanism 100 has the configuration in which the rotation range restricting mechanism 100 is linked to the steering shaft 10 and the rotation of the steering wheel 2 can be restricted, the position where the rotation range restricting mechanism 100 is attached is not limited to that described above.

### Fifth Modification

In the above-described embodiment, in the steering device 1, the steering torque is input to the steering wheel 2 by the driver, and the steering shaft 10 is rotated in accordance with the rotation of the steering wheel 2. The present invention is not limited thereto, and the steering torque may be input to the steering wheel 2 and the steering shaft 10 by a motor, etc. in an autonomous driving vehicle. In other words, it is also possible to apply the rotation range restricting mechanism 100 even to the autonomous driving vehicle.

The configurations, operations, and effects of the embodiments of the present invention will be collectively described below.

The rotation range restricting mechanism 100 for the steering wheel 2 of the steering device 1, in which the steering wheel 2 into which the steering torque is input and the wheels 3 steered in response to the steering torque are mechanically separated, includes: the case 40 having the accommodating hole 41; and the plurality of disks 50, each serving as rotating member, linked to the steering shaft 10 and accommodated in the accommodating hole 41 by being stacked, the steering shaft 10 being configured to be rotated in accordance with the rotation of the steering wheel 2, wherein the plurality of disks 50 each have: the main body portion 51 having a disk shape; the boss portion 52 formed on the main body portion 51 so as to protrude from the main body portion 51 in one of the axial directions; the boss receiving portion 53 formed in the surface of the main body portion 51 opposite from the boss portion 52, the boss receiving portion 53 being configured to rotatably support the boss portion 52 of the disk 50 stacked adjacently; and the stopper portion 54 formed on the outer circumferential surface of the main body portion 51 so as to be slidable along the outer circumferential surface of the disk 50 that is stacked adjacently, the plurality of disks 50 are rotated together as the stopper portions 54 of the disks 50 stacked adjacently come into contact with each other, and the case 40 has the restricting portion 44 configured to restrict the rotation of the disk 50 as a whole as the stopper portion 54 of the disk 50 stacked on the bottom surface 41a of the accommodating hole 41 comes into contact with the restricting portion 44.

In this configuration, the plurality of disks 50 are rotatably stacked via the boss portions 52 and the boss receiving portions 53. Therefore, there is no need to provide a shaft penetrating through the plurality of disks 50 and a bearing that supports such a shaft in order to support the plurality of disks 50. In addition, the stopper portion 54 for transmitting the rotation of the steering wheel 2 is formed integrally to the disk 50, and as the stopper portion 54 of the disk 50, which is stacked on the bottom surface 41a of the accommodating hole 41 in the case 40, comes into contact with the restricting portion 44 of the case 40, the rotation of the disk 50 as a whole is restricted. Therefore, the number of parts of the rotation range restricting mechanism 100 is reduced, and thus, it is possible to restrict the rotation of the steering wheel 2 with a simple configuration.

In addition, among the plurality of stacked disks 50, the disk 50a closest to the steering shaft 10 has the coupling portion 55 capable of coupling to the steering shaft 10.

In this configuration, the assembly of the rotation range restricting mechanism 100 becomes easier.

In addition, the plurality of disks 50 are formed in the same shape as each other.

In this configuration, because the disks 50 having the same shape can be used, it is possible to make the manufacture and the assembly of the rotation range restricting mechanism 100 easier.

In addition, in the bottom surface 41a of the accommodating hole 41 of the case 40, the groove 43 for guiding the stopper portion 54e of the disk 50e stacked on the bottom surface 41a is formed in the circumferential direction, and the restricting portion 44 is formed at the end portion of the groove 43.

In this configuration, because the groove 43 and the restricting portion 44 are formed in the case 40 for receiving the plurality of disks 50, the number of parts of the rotation range restricting mechanism 100 is reduced.

In addition, in the reaction force application device 30 having the reaction motor 4 configured to apply the steering reaction force to the steering wheel 2 and the rotation range restricting mechanism 100, the rotation range restricting mechanism 100 for the steering wheel 2 is configured such that the case 40 is attached to the housing 31 of the reaction motor 4.

In this configuration, it is possible to apply the rotation range restricting mechanism 100 to the reaction force application device 30 only by attaching the case 40 of the rotation range restricting mechanism 100 to the housing 31 of the reaction motor 4.

Embodiments of the present invention were described above, but the above embodiments are merely examples of applications of the present invention, and the technical scope of the present invention is not limited to the specific constitutions of the above embodiments.

With respect to the above description, the contents of application No. 2022-211376, with a filing date of Dec. 28, 2022 in Japan, are incorporated herein by reference.

1. A rotation range restricting mechanism for a steering wheel of a steering device, in which the steering wheel into which steering torque is input and a wheel steered in response to the steering torque are mechanically separated, the rotation range restricting mechanism comprising:
a case having an accommodating hole; and
a plurality of rotating members linked to a steering shaft and accommodated in the accommodating hole by being stacked, the steering shaft being configured to be rotated in accordance with rotation of the steering wheel, wherein
the plurality of rotating members each have:
a main body portion having a disk shape;
a boss portion formed on the main body portion so as to protrude from the main body portion in one of axial directions;
a boss receiving portion formed in a surface of the main body portion opposite from the boss portion, the boss receiving portion being configured to rotatably support the boss portion of a rotating member stacked adjacently; and
a stopper portion formed on an outer circumferential surface of the main body portion so as to be slidable along an outer circumferential surface of the rotating member stacked adjacently,
the plurality of rotating members are rotated together as the stopper portions of the rotating members stacked adjacently come into contact with each other, and
the case has a restricting portion configured to restrict rotation of the rotating members as a whole as the stopper portion of the rotating member stacked on a bottom surface of the accommodating hole comes into contact with the restricting portion, and
among the plurality of stacked rotating members, only a rotating member closest to the steering shaft is directly linked to the steering shaft.

2. (canceled)

3. The rotation range restricting mechanism for the steering wheel according to claim 1, wherein
the plurality of rotating members are formed in a same shape as each other.

4. The rotation range restricting mechanism for the steering wheel according to claim 1, wherein
in the bottom surface of the accommodating hole of the case, a groove for guiding the stopper portion of the rotating member stacked on the bottom surface is formed in a circumferential direction, and
the restricting portion is formed at an end portion of the groove.

5. A reaction force application device comprising the rotation range restricting mechanism for the steering wheel according to claim 1 and a reaction motor configured to apply steering reaction force to the steering wheel and, wherein
the rotation range restricting mechanism for the steering wheel is configured such that the case is attached to a housing of the reaction motor.

6. A reaction force application device comprising:
a rotation range restricting mechanism for a steering wheel of a steering device, in which the steering wheel into which steering torque is input and a wheel steered in response to the steering torque are mechanically separated; and
a reaction motor configured to apply steering reaction force to the steering wheel, wherein
the rotation range restricting mechanism comprises
a case having an accommodating hole, and
a plurality of rotating members linked to a steering shaft and accommodated in the accommodating hole by being stacked, the steering shaft being configured to be rotated in accordance with rotation of the steering wheel,
the plurality of rotating members each have:
a main body portion having a disk shape;
a boss portion formed on the main body portion so as to protrude from the main body portion in one of axial directions;
a boss receiving portion formed in a surface of the main body portion opposite from the boss portion, the boss receiving portion being configured to rotatably support the boss portion of a rotating member stacked adjacently; and
a stopper portion formed on an outer circumferential surface of the main body portion so as to be slidable along an outer circumferential surface of the rotating member stacked adjacently,
the plurality of rotating members are rotated together as the stopper portions of the rotating members stacked adjacently come into contact with each other,
the case has a restricting portion configured to restrict rotation of the rotating members as a whole as the stopper portion of the rotating member stacked on a bottom surface of the accommodating hole comes into contact with the restricting portion, and
the rotation range restricting mechanism for the steering wheel is configured such that the case is attached to a housing of the reaction motor at a side opposite to the reaction motor.
